(19) United States
(12) Patent Application Publication
(10) Pub. No.: US 2008/0271623 A1
(43) Pub. Date: Nov. 6, 2008

(54) Method and Device for Producing Printed Products

(75) Inventor: H. Ulrich Stauber, Grut (CH)

Correspondence Address: RANKIN, HILL & CLARK LLP, 38210 Glenn Avenue, WILLOUGHBY, OH, 44094-7808, US

(73) Assignee: FERAG AG, Hinwil (CH)

(21) Appl. No.: 12/095,854

(22) PCT Filed: Nov. 23, 2006
(86) PCT No.: PCT/CH2006/000655

§ 371 Date: Jun. 20, 2008

(30) Foreign Application Priority Data
Dec. 2, 2005 (CH) 1917/05

(51) Int. Cl. B41F 5/02

(52) U.S. Cl. 101/229

(57) ABSTRACT

The invention relates to printed products which are folded once, twice or three times, are ejected by a rotary printing machine, or produced by a rotation, are stored temporarily, and then ejected by storage units. The printed products are folded essentially in the center and stitched optionally along the additional fold (F). They are then cut in such a way that the first folded edges (F.1) produced in the rotation, and optionally second and third folded edges (F.2 and F.3), are eliminated. In this way, multiple page stitched printed products are created, the printed products consisting of a plurality of sheets folded inside each other, and having a format that can be derived from the basic format of the rotation.

### BACKGROUND OF THE INVENTION

The invention lies in the field of the further processing of printed products, and relates to a method and to a device according to the preambles of the respective patent claims. The method and device serve for the manufacture of multi-sided printed products.

Multi-sided printed products, in particular multi-sided and stitched printed products, are for example, manufactured by way of collecting folded sheets on saddle-like rests and subsequent stitching (stapling) on the rests. Rotary printing machines are usually designed, in order to manufacture multi-sided and stitched printed products in a direct manner. Such multi-sided printed products are usually cut at two or three edges.

Usually the printed products which are to be manufactured with newspaper printing, which are formed by a rotary printing machine, are finished newspapers or magazines. These, as the case may be, are completed by previously printed attachments, and then stacked and packaged, but they are usually not themselves changed by way of a further processing. The rotary printing machine processes paper webs of usually 1,260 mm width, which are printed on both sides and then, in a different manner and depending on the product to be manufactured, are cut lengthwise, folded lengthwise, transversely cut and/or transversely folded.

The products formed by the rotary printing machine are, thus for example folded once, and have a format of 235×315 (tabloid, for example 4 or 16 sheets folded in one another) or a format of 315×470 mm, (newspaper section, for example two sheets folded in one another, which form a booklet, or four booklets lying on one another). The products folded twofold usually have a format of 315×235 mm (newspapers folded twice, which consist of a booklet or of a plurality of booklets folded in one another). It is also possible to fold products folded twice in the rotary printing machine, for a third time (triple-fold). Also other printed products may be manufactured in the rotary printing machine, as with the printed products which may be manufactured in a rotary printing machine and are mentioned as examples, wherein the formats however may indeed always is be derived from the basic format 1,260×470 mm, essentially by way of repeated halving in the longitudinal direction (parallel to the length of the paper web) and/or in the transverse direction (parallel to the width of the paper web).

### BRIEF SUMMARY OF THE INVENTION

It is now the object of the present invention, to provide a method and a device with which different types of multi-sided printed products may be manufactured in the simplest manner.

The object is achieved by the method and the device, as are defined in the patent claims.

The method according to the invention consists essentially of further processing printed products which are formed by the rotary printing machine, thus printed products (rotary printing machine products) as are described above by way of example, which means folding the printed products an additional time and cutting them in a manner such that the additional fold forms the back of the printed product and all folds created in the rotary printing machine are removed. As the case may be, the products are stitched (stapled) in a manner known per se before or after the additional folding. Of course, the sides of the finished printed product are to be arranged and aligned on the paper web according to their arrangement in the finished product, already on printing the paper web.

As the case may be, the rotary printing machine products are yet completed before the actual folding and, as the case may be, stitching, which means they are completed by way of the addition of part products and/or supplements, which are unified by way of insertion, collecting or collating. The part products or attachments which are added by way of the completing and which may have the same format as the rotary printing machine product or a different one, are thus likewise subjected to the additional folding, and stitching as the case may be.

It is also possible to print two-ups in the rotary printing machine and to process these according to the method according to the invention, and to separate them accordingly after the cutting. Other post-processing is also conceivable.

In the method according to the invention, the printed products manufactured by the rotary printing machine are either processed directly, which means on-line, or they are firstly intermediately stored in windings, piles or stacks, in order to be fed from the storage into the method according to the invention, essentially likewise as a continuous flow (e.g. imbricated flow).

Exemplary embodiments of the method and the device according to the invention, and examples of the printed products which are manufactured by way of this, are described in detail by way of the following figures. Thereby there is shown in:

### BRIEF DESCRIPTION OF THE FIGURES

FIG. 1 a block schema of a device according to the invention, for illustrating the principle of the method;

FIG. 2 the inventive manufacture of multi-sided printed products, which are stitched as the case may be, from rotary printing machine products which are folded once (tabloid);

FIG. 3 the inventive manufacture of multi-sided printed products which are stitched as the case may be, from rotary printing machine products which are folded twice (double-fold);

FIG. 4 the inventive processing of rotary printing machine products in the form of two-ups.

### DETAILED DESCRIPTION OF THE INVENTION

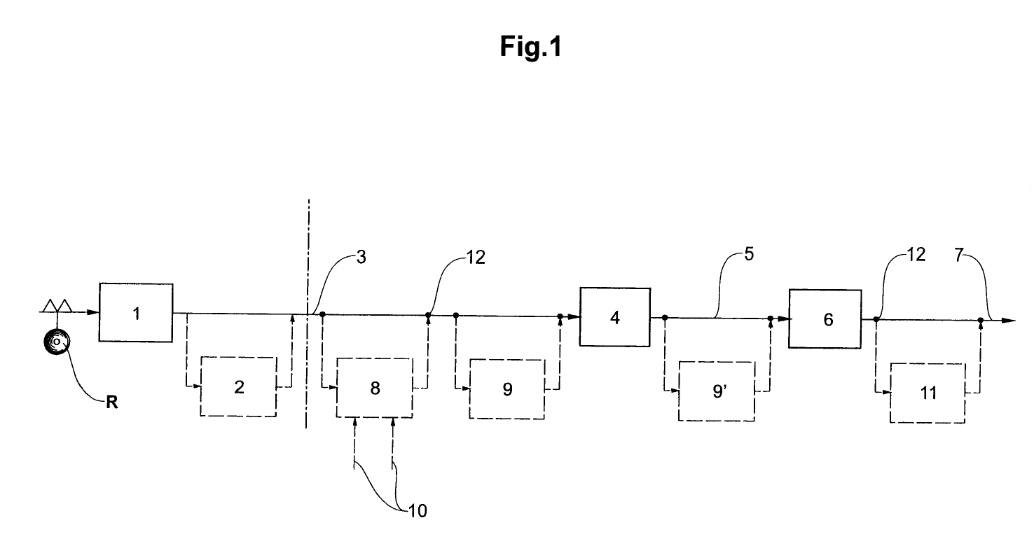

FIG. 1 is a block schema of the device according to the invention, for carrying out the method according to the invention. Boxes which are drawn in an unbroken manner, represent the devices which are necessary for the invention, or necessary method steps, and boxes shown dashed represent optional devices or optional method steps. The lines connecting the boxes with one another in the arrow directions represent the conveyor paths, on which the printed products are conveyed from processing station to processing station (full lines: conveyor paths for the simplest embodiment form; dashed lines: additional or optional conveyor paths).

It is also possible to realize a very simple device (only unbroken units) and thus essentially to only carry out the simplest embodiment of the method according to the invention. Likewise, it is possible to set up a device with the necessary devices and one or more optional devices and, thus, always to carry out an embodiment of the method which always remains the same. Furthermore, it is also possible to provide the necessary devices and a plurality of optional devices, and to design the conveyor means between the devices with controllable shunts, in a manner such that optimal devices or method steps may be selectively bypassed. One may process different or equal rotary printing machine products according to different embodiments of the method according to the invention, in a flexible manner with such devices.

The processing devices and the conveyor devices of the device according to the invention are all essentially known and for this reason are not described in detail hereinafter.

The device according to the invention connects on-line to a rotary printing machine 1 and/or to a station 2. The rotation 1 processes rolls R of paper webs into rotary printing machine products. The station 2 creates an essentially continuous feed flow of rotary printing machine products from storage formations of rotary printing machine products (e.g. windings, piles or stacks). An intermediate storage (not shown), in which storage formations are created from rotary printing machine products of the rotary printing machine 1 and intermediately stored, may be arranged upstream of the station 2. The rotary printing machine products may, however, also be manufactured from other rotary printing machines and be delivered in storage formations for the processing according to the invention.

The device according to the invention begins in FIG. 1 with the perpendicular, dot-dashed line with a feed conveyor 3 for the feed of the rotary printing machine products. According to the simplest embodiment of the method according to the invention, the supplied rotary printing machine products are directly subjected to the additional folding (folding device 4) and then intermediately conveyed (intermediate conveyor 5), cut (cutting device 6) and then transported away (lead-away conveyor 7).

In a selective manner, the rotary printing machine products which are supplied to the device according to the invention, are completed before the additional folding (completing device 8) and/or stitched along a middle line (stitching device 9). The completing device 8 thereby is, for example, a device for collecting (e.g. collection drum) for inserting (e.g. insert drum) or a system for collation, wherein the part products and/or attachments to be added to the rotary printing machine products are fed with the help of a further feed conveyor 10.

After the folding (folding device 4) and before the cutting (cutting device 6), the printed products may be optionally stitched (stitching device 9′). After the cutting (cutting device 6), they may yet be post-processed (post-processing station 11). The post-processing station 11 may have one or more post-processing devices, for example a device for separating two-ups, a device for addressing, a device for spine gluing non-stitched printed products, a device for a further completion (e.g. gluing in cards, patterns or small leaflets) etc.

If the device according to the invention comprises one or more of the optional devices 8, 9, 9′ and/or 11, the printed products are led to and away from these devices via corresponding part pieces of the feed conveyor 3, intermediate conveyor 5 and/or lead-away conveyor 7 in an unchanging manner. However, one may also provide suitable shunts (points 12), so that the printed products may run through a different sequence of processing steps depending on the shunt position.

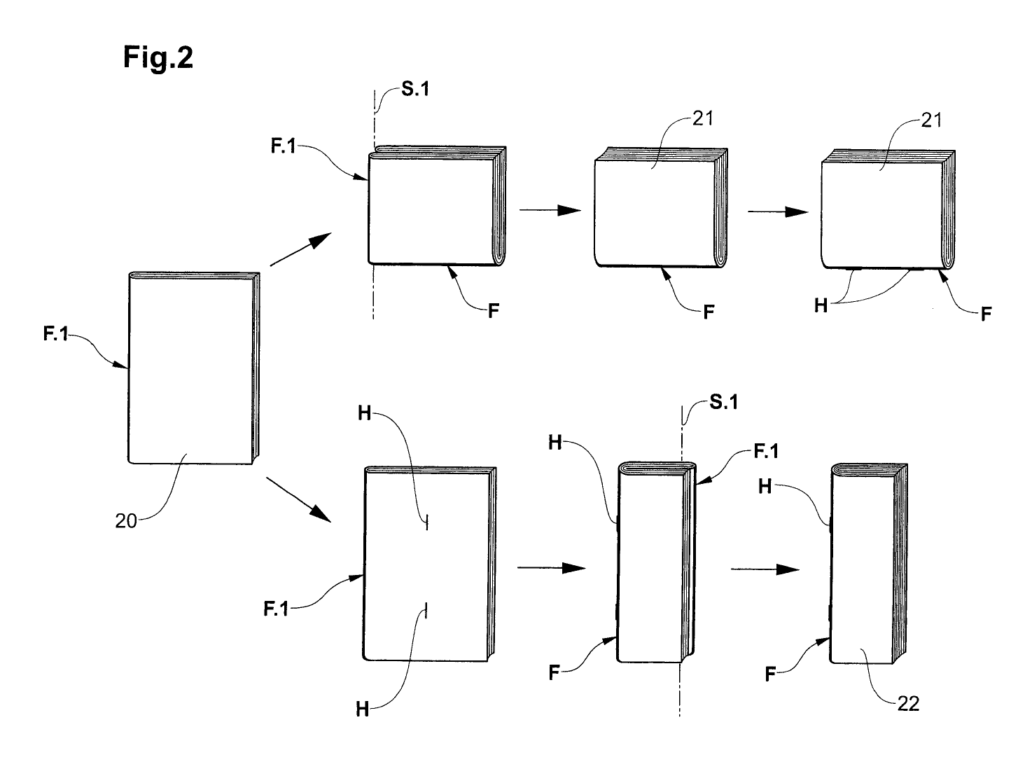

FIGS. 2 to 4, for example, show rotary printing machine products which are processed according to the method according to the invention. The examples represented in the Figures only illustrate a very small selection of embodiments of the method according to the invention and of printed products which may be manufactured therewith. The invention is in no way limited to these examples, but includes the processing of all products of the rotary printing machine by at least additional folding and cutting, and the printed products which may be created by this.

FIG. 2 shows two embodiments of the method according to the invention, which proceed from a rotary printing machine product 20 folded once. The rotary printing machine product 20 has a fold edge F.1 (first fold). It is a tabloid for example, and consists of four sheets folded in one another (16 printed sides). The height of the rotary printing machine product is essential halved and the additional fold edge F arises by the step of the additional folding transversely to the fold edge F.1, which may be carried out selectively with or without a pre-fold. The printed product arises by way of cutting the first fold edge F.1 (along the cutting line S.1 which is represented in a dot-dashed manner) and this printed product consists of sheets which are folded in one another, has 32 printed sides and has a format of about 157×225 mm, for example. The printed product 21 may be yet additionally stitched (stitching H). Of course, additionally to the cutting along the cutting line S.1, the other edge of the additional folded product, which is parallel to the cutting line S.1, may likewise be cut

FIG. 2 as a further embodiment of the method according to the invention, proceeding from the same rotary printing machine product 20 folded once (e.g. tabloid with 16 printed sides), shows a stitching carried out before the additional folding, along a middle line running parallel to the first fold edge F.1, an additional folding along the stitching line, and cutting in the region of the first fold edge F.1 (cutting line S.1). This embodiment of the method according to the invention leads to a printed product 22, which, as with the printed product 21, consists of sheets folded in one another and has a format of approx. 117×315 mm. With a suitable stitching and in particular printing of the sides, the printed product 22 may also be a two-up, which after the cutting of the first fold edge F.1 would be separated transversely to the additional fold edge in the middle into two printed products (see embodiment of the method according to the invention, according to FIG. 4).

In the two embodiment forms of the method according to the invention, which are represented in FIG. 2, the rotary printing machine products 20 may of course be completed before the additional folding and, as the case may be, the stitching, which means that an equal rotary printing machine product or a plurality of equal rotary printing machine products which, for example, were printed earlier, may be deposited onto a rotary printing machine product 20 by way of collating. The resulting printed product 21 or 22 would then have accordingly more sides than in the embodiment described above.

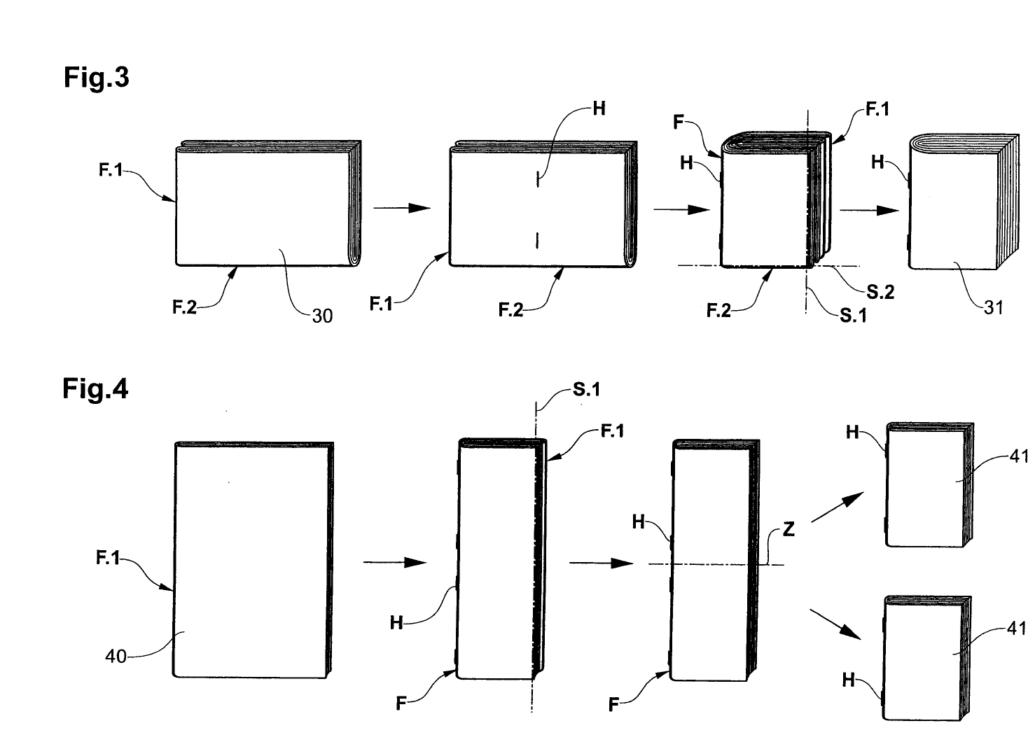

FIG. 3 shows a further exemplary embodiment of the method according to the invention. The rotary printing machine product 30 in this case is folded twice (first fold edge F.1 and second fold edge F.2). It consists, for example, of two sheets folded into one another and has a format of 315×235 mm (newspaper format). It is stitched along a middle line transversely to the second fold edge F.2 and is additionally folded (additional fold edge F) and then cut in the region of the first and second fold edges F.1 and F.2 (cutting lines S.1 and S.2) or in the region of all three edges (except for the additional fold edge). The arising printed product 31 consists of eight sheets which are folded in one another, thus has 22 printed sides and a format of approx. 157×235 mm. Of course, the rotary printing machine product 30 in this embodiment of the method according to the invention may also be completed before the additional folding and stitching as the case may be, for example by way of one or more supplements being inserted into the rotary printing machine product 30. The supplement or supplements may thereby have the same format as the rotary printing machine product 20, or they may also be smaller. If the supplements have a smaller format, then with a respective alignment of the attachments relative to the rotary printing machine products, one must ensure that all attachments are folded and as the case may be, also stitched and thus become an integral component of the finished printed product 31.

FIG. 4 shows a further, exemplary embodiment of the method according to the invention. The rotary printing machine product 40 which is processed in this embodiment, is folded once (first fold edge F.1) and the printed sides are arranged and aligned in the context of a two-up. The rotary printing machine product for example, as an individual booklet (or signature) of a newspaper consists of two sheets which are folded in one another and has a format of 315×470 mm. Half a sheet may yet also lie in the inside of the two sheets. The rotary printing machine product 40 is folded in the middle parallel to the first fold edge F.1 (additional fold edge F) and is stitched (stitching H), wherein the stitching should have no middle staple. Then the product is cut in the regions of the first fold edge F.1 or at three sides (cutting line S.1) and subsequently is separated at the middle transversely to the additional fold edge F (separation line Z). Two printed products arise, which in each case have 16 printed sides (with half a sheet: 24 printed sides) and a format of approx. 157×235 mm. Depending on the printing of the paper web, the two printed products 41 are equal or different to one another.

Of course, it is also possible to separate a correspondingly printed rotary printing machine product (multiple-up) after the additional folding and cutting into more than two printed products, which then have correspondingly smaller formats. In the embodiment of the method according to the invention, as is represented in FIG. 4, it is also possible to complete the rotary printing machine product before the additional folding and, as the case may be, the stitching, wherein the part products and/or supplements to be added are to be designed with as a two-up or multiple-up.

1-14. (canceled)

15. A method for manufacturing multi-sided, in particular multi-sided and stitched printed products, comprising the steps of:
providing a rotary printing machine product which is manufactured in a rotary printing machine, and is folded once, twice or three times, and comprises first fold edges, first and second fold edges or first, second and third fold edges produced in the rotary printing machine;
folding the rotary printing machine product at the middle for producing an additional fold edge; and
removing the first fold edge, the first and second fold edges or first, second and third fold edges by cutting the products transversely or parallel to the additional fold edge.

16. A method according to claim 15, further comprising the step of stitching the rotary printing machine products along the line of additional folding before or after the additional folding step.

17. A method according to claim 15, further comprising the step of completing the rotary printing machine products before the additional folding step.

18. A method according to claim 15, further comprising the steps of feeding the rotary printing machine products on-line from the rotary printing machine or from storage formations.

19. A method according to claim 15, further comprising the step of printing the rotary printing machine products as two-ups or multiple-ups, and, after the additional folding or cutting, separating the rotary printing machine products transversely to the additional fold edge.

20. A method according to claim 15, wherein the rotary printing machine products consist of folded sheets and have a first fold edge and wherein the additional folding is carried out transversely to the first fold edge, and the cutting is carried out transversely to the additional fold edge.

21. A method according to claim 15, wherein the rotary printing machine products consist of folded sheets and comprise a first fold edge, and wherein the additional folding is carried out parallel to the first fold edge, and the cutting is carried out parallel to the additional fold edge.

22. A method according to claim 15, wherein the rotary printing machine products consist of folded sheets and comprise a first and second fold edge and wherein the additional folding is carried out transversely or parallel to the second fold edge, and the cutting is carried out transversely and parallel to the additional fold edge.

23. A device for manufacturing multi-sided, in particular multi-sided and stitched printed products, comprising:
a folding device,
a cutting device,
a feed conveyor and
an intermediate conveyor,
wherein the feed conveyor connects the exit of a rotary printing machine and/or a station for the disaggregation of storage formations of the printed products, to the folding device, and the intermediate conveyor connects the folding device to the cutting device.

24. A device according to claim 23, wherein a lead-away conveyor is provided for conveying of the printed products away from the cutting device.

25. A device according to claim 23, further comprising a completion device and/or a stitching device, wherein the feed conveyor comprises parts, by way of which the rotary printing machine products may be led to the completion device and away from this, and or to the stitching device and away from this, or that the feed conveyor comprises corresponding shunts.

26. A device according to claim 23, further comprising a stitching device, wherein the intermediate conveyor comprises parts, by way of which the rotary printing machine products may be led to the stitching device and away from this, or that the intermediate conveyor comprises corresponding shunts.

27. A device according to claim 24, further comprising a post-processing station, wherein the lead-away conveyor comprises parts, by way of which the rotary printing machine products may be conveyed to the post-processing station and away from this, or wherein the lead-away conveyor comprises corresponding shunts.

28. A device according to claim 27, wherein the post-processing station comprises a separating device for separating two-ups or multiple-ups, a addressing device, a gluing binding device and/or a further completion device.
